(19) United States
(12) Patent Application Publication
(10) Pub. No.: US 2008/0039565 A1
(43) Pub. Date: Feb. 14, 2008

(54) Thixotropic/non-slump room temperature curable organopolysiloxane compositions

(75) Inventors: Martin B. Ridley, Weston-super-Mare (GB); William T. Flannigan, Taunton (GB)

Correspondence Address: PATTON BOGGS, L.L.P., 2001 ROSS AVENUE, SUITE 3000, DALLAS, TX, 75201, US

(73) Assignee: Amber Chemical Company

(21) Appl. No.: 11/974,396

(22) Filed: Oct. 11, 2007

Related U.S. Application Data
(63) Continuation-in-part of application No. 10/495,019, filed on May 10, 2004.

(51) Int. Cl. C08L 83/04; C08K 3/22; C08K 3/36

(52) U.S. Cl. 524/403; 524/431; 524/588

(57) ABSTRACT

A method and composition for making a RTV organopolysiloxane composition including mixing in the following preferable order: at least one organopolysiloxane polymer molecule (component A), an organic silicon compound (component D), an organic silicon compound (component E), a first portion of an amino-functional silane or derivative of such substance (component C1), a finely divided hydrophobised silica filler (component B1), a finely divided hydrophilic silica filler (component B2), a second portion of an amino-functional silane or derivative of such substance, and an organic imine curing catalyst.

### CROSS-REFERENCE TO RELATED APPLICATIONS

This application is a continuation-in-part of prior U.S. patent application Ser. No. 10/495,019, filed May 10, 2004, which was the National Stage of International Application No. PCT/GB02/03940 filed Aug. 29, 2002. The entireties of these aforementioned applications are incorporated herein by reference.

### FIELD OF THE INVENTION

This invention generally relates to a process for producing room temperature, moisture curable organopolysiloxane compositions for use as adhesive sealants and coatings. Specifically, this invention relates to the process of manufacture of thixotropic or non-slump room temperature vulcanisable (RTV) organopolysiloxane compositions which are readily cured in the presence of atmospheric moisture to form elastomers and more specifically, to such RTV compositions which are curable into rubbery elastomers having improved primerless adhesion and non-corrosive properties to sensitive substrates which are otherwise difficult to bond.

### PROBLEM

Room temperature vulcanisable (curable) compositions (known as RTV's) based on the so-called condensation reactions of silanes and hydroxyl-terminated organopolysiloxanes are well known to those in the art. These compositions are cured by exposure to atmospheric moisture to form elastomeric materials that are widely used as adhesive sealants, gaskets and potting agents in a wide variety of applications ranging from electrical and electronics to aerospace and construction. The most commercially desirable products are the non-flowable thixotropic sealants.

Many silicone sealants are unsuitable for certain applications because of their corrosive effects on sensitive metals such as copper and its alloys. These silicone sealants typically include an amino-functional silane as an internal adhesion promoter that have been shown to cause corrosion on copper and its alloys often in the presence of certain crosslinking agents and organometallic catalysts.

Further, many silicone sealants are unsuitable for some applications due to their limited adhesion to various substrates. These substrates often require priming to achieve satisfactory adhesion. Priming substrates is disadvantageous from the time and cost standpoints.

Most catalysts used in silicone sealants are organometallic compounds, the most common of which are organo-tin substances. Many such catalysts are classified as “harmful to the environment.” In addition many organo-tin catalysts exhibit toxic and/or irritant characteristics. Organometallic catalysts, such as dibutyltin dilaurate, have been shown to cause premature gelation and curing of sealants of the type described.

In addition, these types of RTVs that are produced according to commonly known methods are so-called flowable or slumping sealants and these are generally deemed to be much less commercially attractive than thixotropic/non-slumping types would be. To increase the thixotropic properties of these RTVs, it has been proposed to simply add untreated hydrophilic fumed silica to achieve the desired effects, as this is the case with the familiar acetoxy, oxime, and alkoxy silicone sealants.

In the process of manufacturing the sealants according to currently used techniques, it was found that the most effective and cost effective thixotroping agents known to those skilled in the art are untreated fumed silicas, such as for example Aerosil® 150, Aerosil® 200, Aerosil® 300 (Degussa) and their equivalent products from Wacker Chemie and Cabot. However, some untreated silicas exhibit unacceptable side effects when mixed with contemporary sealants reactants resulting in the formation of pips, solid agglomerates, and imperfections in the finished products. Such interference renders the products totally unsuitable for commercial use.

In attempts to increase the thixotropic properties of the RTVs, it was found that there is a stage where the viscosity of the mix increases rapidly due to interaction of the fillers with the crosslinking agent. In some of the more extreme cases of attempts to produce thixotropic products, it was not uncommon for the entire mix to become so viscous that it would climb the mixing shaft of the mixing equipment. This resulted in the mix adhering to the upper area of the mixing equipment, which is disastrous for commercial operations.

A secondary effect of the use of untreated fumed silicas of these formulations is encountered during aging, storing, or both. This results in the gradual formation of undesirable agglomerates which rendered the products unsuitable for sale.

Information relevant to attempts to address these problems can be found in U.S. Pat. Nos. 5,969,075 issued 19 Oct. 1999 to Inoue; 4,487,907 issued 11 Dec. 1984 to Fukayama, et al.; 5,525,660 issued 11 Jun. 1996 to Shiono, et al.; 6,214,930 issued 10 Apr. 2001 to Miyake, et al. and 4,973,623 issued 27 Nov. 1990 to Haugsby, et al.

### SOLUTION

The above described problems are solved and a technical advance achieved by the present RTV organopolysiloxane composition. Excellent curing characteristics have been achieved by using a novel combination of a crosslinking agent, adhesion promoter, and non-organometallic curing catalyst in combination with a novel method of manufacturing the RTV organopolysiloxane composition.

The purpose of this invention is to provide a method of preparing silicone adhesive sealants that cure at room temperature in the presence of atmospheric moisture, possess excellent primerless adhesion to many substrates and do not exhibit unacceptable side effects resulting in the formation of pips, solid agglomerates and imperfections in the finished products.

The invention describes a means of preparing and curing a condensation-cure one-component silicone adhesive sealant without the use of organometallic catalysts. The invention uses an organic imine, such as 1,1,3,3-Tetramethylguanidine, thereby removing the need for organometallic catalysts. In conjunction with certain alkoxysilanes the organic imine obviates the need for an extremely expensive and complex guanidyl silane. Further, the novel method of manufacturing the RTV organopolysiloxane composition provides improved thixotropic/non-slumping properties over previous so-called flowable or slumping RTV sealants. Additionally, these sealants offer good shelf-life stability and relatively fast curing properties.

The present RTV organopolysiloxane composition consists of a number of components, which are combined in the manner described below to produce a condensation-cure one-component silicone adhesive sealant without the use of organometallic catalysts. These components include an organopolysiloxane having at least two hydroxyl groups attached to the terminal silicon atoms of the molecule, combined with a silica filler that is added to provide physical strength to the cured elastomer. In addition, an amino-functional silane and a silane crosslinking agent are added to the composition. Additional components can be added to the composition to control the rate of cure of the sealants of this invention and snappiness of the cured elastomer, and to provide other characteristics as are described below.

The solution to the problem of obtaining good thixotropy and smooth spreadable commercially viable products was achieved by the use of a blend of hydrophobic and hydrophilic fumed silicas and by controlling the order of addition and the specific quantities of each component. In particular the amino functional silanes employed as adhesion promoters were found to have a significant controlling influence on the rheology and quality of the finished product. By careful inclusion of part of the “adhesion promoting silanes” the interference caused by the subsequent addition of untreated fumed silicas was eliminated.

In one embodiment of the present RTV organopolysiloxane composition, the amount of amino-functional silane (Component C) is split into to two portions where a first portion of Component C (Component C1) is added to the mixture containing Component A, Component D, and preferably Component E prior to addition of the hydrophobised fumed silica (Component B1), followed by the addition of the hydrophilic fumed silica (Component B2). Then, the mixture is completed by adding a second portion of Component C (Component C2), followed by the additions of Component F. Splitting Component C into 2 parts, Component C1 and Component C2, and adding them into the mixture in a specific order produces a commercially viable thixotropic RTV organopolysiloxane sealant.

### DETAILED DESCRIPTION

The present RTV organopolysiloxane composition consists of a number of components, which are combined in the manner described below to produce a condensation-cure one-component silicone adhesive sealant without the use of organometallic catalysts. The present invention is a RTV organopolysiloxane composition comprising (A) an organopolysiloxane having at least two hydroxyl groups attached to the terminal silicon atoms of the molecule, (B) finely divided silica filler, (C) an amino-functional silane containing at least one amino-group per molecule, (D) a silane crosslinking agent, (E) a trialkoxysilane, and (F) an organic imine or substituted imine.

Component (A) is an organopolysiloxane having at least two hydroxyl groups attached to the terminal silicon atoms of the molecule. Preferably, it is an organopolysiloxane blocked with a hydroxyl group at either end represented by the following formula (1).

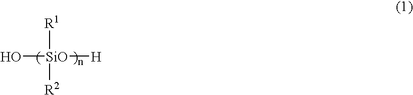

In formula (1), groups R¹ and R², which may be the same or different, are independently selected from substituted or unsubstituted monovalent hydrocarbon groups having 1 to 10 carbon atoms, for example methyl, ethyl, propyl, butyl, cyclohexyl, vinyl, allyl, phenyl, tolyl, benzyl, octyl, 2-ethylhexyl or groups such as trifluoropropyl or cyanoethyl. The preferred groups are methyl. The latter may be substituted by trifluoropropyl or phenyl to impart specific properties to the cured elastomer. Letter n is such an integer that the diorganopolysiloxane may have a viscosity of 50 to 500,000 mPa·s at 25° C., preferably 2,000 to 100,000 mPa·s. Blends of differing viscosities may be used to achieve a desired effect.

Component (B) is finely divided silicon dioxide that is added to provide physical strength to the cured elastomer. Examples of suitable silica fillers include fumed silica, fused silica, precipitated silica and powdered quartz. which are optionally surface treated with silazanes, chlorosilanes or organopolysiloxanes to render them hydrophobic. The preferred silicas are those having a specific surface area of at least 50 m²/g as measured by the BET method. In the case of thixotropic examples of the present invention the preferred thixotroping agents are the hydrophilic fumed silicas. The above silicas may be blended in any desired ratio.

In one aspect of the present RTV organopolysiloxane composition, Component B may be a multi-part component. For example, Component B may comprise a Component B1 that may be a treated hydrophobised fumed silica and a Component B2 that may be an untreated hydrophilic fumed silica. Preferably, Components B1 and B2 may be added sequentially with the addition of Component B1 first followed by the addition of Component B2 prior to the addition of Component C2 as further described below.

Component (C) is an amino-functional silane containing at least one amino-group per molecule. Illustrative examples of the amino-functional silane are given below. The principal function of the amino-functional silane is to promote good adhesion between the silicone sealant of the present invention and appropriate substrates.

Component (C) is a compound of the following formula: 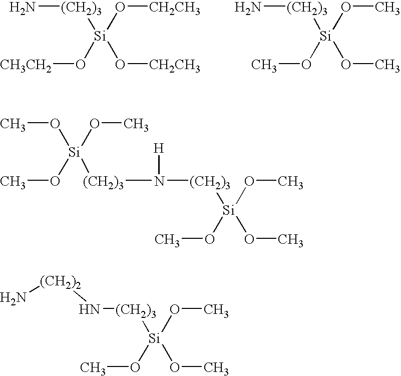
Suitable silanes are available from Crompton OSi Specialities under the trade identity Silane A-1100: γ-aminopropyltriethoxysilane, Silane A-1110: γ-aminopropyltrimethoxysilane, Silane A-1120: β-aminoethyl-γ-aminopropyltrimethoxysilane, Silane A-1130: Triaminofunctional silane, Silane Y-9669: N-phenyl-γ-aminopropyltrimethoxysilane, Silane A-1170: Bis-[γ-(trimethoxysilyl)propyl]amine and Silane A-2120: N-β-aminoethyl-γ-aminopropylmethyldimethoxysilane.

In one embodiment of the present RTV organopolysiloxane composition, Component C may be also split into two portions, Component C1 and Component C2 for providing a novel RTV organopolysiloxane composition having good thixotropic, non-slumping properties. In one aspect, a preferred ratio of Component C1 to Component C2 is between 15:85 and 70:30. More preferably, the ratio of Component C1 to Component C2 is between 25:75 and 50:50. Further, preferably the total concentration of Component C1 and Component C2 is between 0.1 and 5.0 parts by weight. More preferably, the total concentration of Component C1 and Component C2 is between 0.5 and 1.5 parts by weight.

Further, one of the inventive aspects of the present RTV organopolysiloxane composition is the fact that by adding the Component C1 in the order described herein it overcomes the adverse effects of the untreated hydrophilic fumed silicas (Component B2) as thixotroping agents, thus preventing the formation of undesirable aggregrates or “pips” in the finished RTV organopolysiloxane products. It is commonly known in the art that untreated fumed silicas are hydrophilic because of the relatively high concentration of hydroxyl groups attached to the silicon atoms. These hydroxyl groups are well documented and are known to exhibit much greater acidity and reactivity than similar groups on the terminal silicon atoms of the so-called silanol polymers. It could of course be hypothesised that the amino-group of the amino-functional silane is simply neutralizing these acidic hydroxyl-functionalities on the hydrophilic fumed silicas. If this were so, then the use of small quantities of ammonia (a more basic and much cheaper base) should in theory have a similar effect; however, this is not the case.

Without being limited to a particular theory, it is believed that the alkoxy groups of the amino-functional silane (Component C1) react with the hydroxyl functionalities of the fumed silica and that this reaction is catalysed by the amino-group in the same molecule. Such removal of hydroxyl functionality is known in the art as “capping.”

Component (D) is a silane crosslinking agent represented by the following formula (2).
RₙSiX₄₋ₙ (2)

In formula (2) R represents a substituted or unsubstituted monovalent hydrocarbon group of 1 to 10 carbon atoms, X is a 1-methyvinyloxy (also known as isopropenyloxy) group, and letter n is equal to 0, 1 or 2. Preferably, the silane crosslinking agent is selected from methyl tris-isopropenyloxy silane, vinyl tris-isopropenyloxy silane, phenyl tris-isopropenyloxy silane or combinations of the aforesaid crosslinking agents.

Component (E) is a trialkoxysilane that is employed to control the rate of cure of the sealants of this invention and improve the snappiness of the cured elastomer. Component (E) is represented by formula (3)
RₚSiX₄₋ₚ (3)

In formula (3) R represents a methyl, vinyl or substituted vinyl group and X is a methoxy or ethoxy group or a mixture of methoxy and ethoxy groups. Letter p is equal to 0, 1 or 2. Some examples of suitable silanes are available from Compton OSi Specialities under the trade identity: Silane A-162: Methyltriethoxysilane, Silane A-163: Methyltrimethoxysilane, Silane A-151: Vinyltriethoxysilane and Silane A-171: Vinyltrimethoxysilane.

Component (F) is an organic imine or a substituted imine, which is used as a catalyst and is of the general formulas (4a) and (4b): 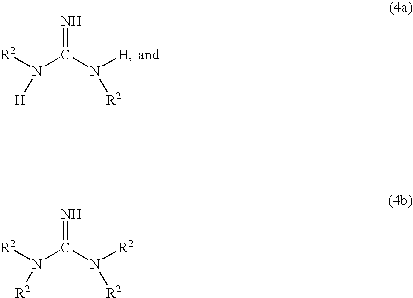
wherein R² is independent and selected from methyl, isopropyl, phenyl and ortho-tolyl groups. Some examples of the organic imine or substituted imine include: 1,3-Diphenylguanidine, 1,3-Di-o-tolylguanidine, 1,3-Dimethylguanidine and 1,1,3,3-Tetramethylguanidine. The preferred compound is 1,1,3,3-Tetramethylguanidine.

Other materials such as bulking fillers, for example micronised quartz, calcium carbonate, talc, magnesium oxide, aluminium oxide and aluminosilicates may be used insofar as the main properties of the sealants are not affected. Useful additives such as iron oxide, titanium dioxide and cerium oxide for thermal stability, fungicidal compounds for extended protection; carbon black, titanium dioxide and other coloured pigments to enhance appearance and fire retardant compounds may be used. Such additives are normally added following addition of Component (B) but may be added at any point to achieve a desired effect. In one aspect, cerium oxide or iron oxide when added to the mixture provide good thermal stability. These additives are preferably added to the mixture after the addition of Component B1. Furthermore, pre-dispersed additive masterbatches are preferably added to the polymers (Component A) during the initial blending and degassing stage. Other dry powdered additives, such as iron oxide powder or carbon black are preferably added following the addition of Component B2. In one aspect, it may be preferable to withhold part of the polymer or polymers (Component A) in order to improve the grind or dispersion of the additives, such as iron oxide powder.

Examples of the invention are given below by way of illustration and not by way of limitation. All parts are by weight.

In addition to the aforementioned aspects included in and embodiments of the present thixotropic non-slump product, the present invention further includes methods for making a thixotropic non-slump product.

### EXAMPLE 1

A uniform mixture was prepared by blending 25 parts by weight of a hydroxyl-terminated polydimethylsiloxane polymer with a viscosity of approximately 50,000 mPa·s with 75 parts by weight of a second hydroxyl-terminated polydimethylsiloxane polymer of viscosity of approximately 10,000 mPa·s (Components A). To the above blend of polymers 6.5 parts by weight of pigment masterbatch was added and blended until a uniform mixture was obtained. To the above blend was added 7.2 parts by weight of Vinyl tris-isopropenyloxy silane (Component D) and 0.4 parts by weight of Vinyltrimethoxysilane (Component E). The latter were mixed into the polymer blend until a smooth dispersion was obtained. This was followed by the addition of a first quantity or portion of Component C. In this example 0.3 parts by weight of γ-aminopropyltriethoxysilane (Component C1) was added.

The addition of Component B to the above mixture was done in accordance with the following. Component B comprises a first element Component B1 that is a treated hydrophobised fumed silica and a second element Component B2 that is an untreated hydrophilic fumed silica. To the above blend was added 13.0 parts by weight of hydrophobised fumed silica (Degussa R972) (Component B1). The latter was mixed into the polymer blend until a smooth, agglomerate-free dispersion was obtained after which approximately 2.0 parts by weight of a hydrophilic fumed silica (Cab-O-Sil LM150) (Component B2) were added and mixed until fully dispersed (These fillers are Components B). A second quantity of 0.3 parts by weight of γ-aminopropyltriethoxysilane (Component C2) was then added followed immediately by 0.5 parts by weight of 1,1,3,3-Tetramethylguanidine (Component F). All the above procedures were carried out under controlled vacuum.

A sealant, Example 1(a) according to the invention and a comparative sealant 1(b) were prepared. The test results are given in Table 1.

TABLE 1

Example

| (Parts by weight) | 1(a) | 1(b) |
|---|---|---|
| Polymer Blend | 100 | 100 |
| Pigment Masterbatch | 6.5 | 6.5 |
| Vinyl tris-isopropenyloxy silane | 7.20 | — |
| Vinyltrimethoxysilane | 0.40 | — |
| Methyl tris-(2-butanoximo)silane | — | 4.50 |
| Vinyl tris-(2-butanoximo)silane | — | 0.70 |
| γ-aminopropyltriethoxysilane (i) | 0.3 | — |
| Aerosil R972 (Degussa) | 13.0 | 13.0 |
| Cab-O-Sil LM150 (Cabot) | 2.0 | 2.0 |
| γ-aminopropyltriethoxysilane (ii) | 0.30 | 0.55 |
| Dibutyltin dilaurate | — | 0.05 |
| 1,1,3,3-Tetramethylguanidine | 0.50 | — |

The above formulations were thixotropic products with a slump of less than 3 mm when tested on a Boeing Jig. They were stable for at least 12 months at ambient temperatures and exhibited no significant change in properties after storing at 40° C. for 3 months.

The following tests were carried out to test the suitability of the products for electronic applications:

Tack Free Time. The time taken for the sealant to form a dry non-adherent skin on the surface following exposure to atmospheric moisture.

Cure Through Time. This is considered to be the time taken after exposure to atmospheric moisture for the sealant to cure to a depth of 3 mm.

Adhesion/Corrosion. The substrates chosen are stainless steel, aluminium, polyester powder coated metal, copper and brass. Corrosion was assessed on a scale of 1 to 5. The higher the mark the worse the corrosive properties.

General Physical Properties as shown in Table 2 were performed on 3 mm thick sheets which had been cured for 7 days at 23° C. and 65% relative humidity in accordance with accepted international standards and industry practice. Samples were also examined for the mode of adhesive failure and for any corrosive action or surface attack.

The results are summarized in Table 2.

TABLE 2

| | Example | | | |
|---|---|---|---|---|
| Test | 1(a) | | 1(b) | |
| Tack Free Time, min | <3 | | 9 to 10 | |
| Cure Through, hours | <16 | | 24 | |
| Tensile Strength, MPa | 2.4 | | 2.3 | |
| Elongation at Break, % | 400 | | 210 | |
| Hardness, Shore A | 40 | | 40 | |
| Adhesion- | Fail Mode | Corrosion | Fail Mode | Corrosion |
| Stainless Steel | Cohesive | 1 | Cohesive | 1 |
| Aluminium | Cohesive | 1 | Cohesive | 1 |
| PC Polyester | Cohesive | 1 | Cohesive | 2 |
| Copper | Cohesive | 1 | Cohesive | 5 |
| Brass | Cohesive | 1 | Cohesive | 4 |

The following example describes a procedure for the manufacture of a thixotropic, high temperature resistant product.

### EXAMPLE 2

A uniform mixture was prepared by blending 40 parts by weight of a hydroxyl-terminated polydimethylsiloxane polymer with a viscosity of approximately 50,000 mPa·s with 60 parts by weight of a second hydroxyl-terminated polydimethylsiloxane polymer of viscosity of approximately 10,000 mPa·s (Components A). To the above blend was added 7.8 parts by weight of Vinyl tris-isopropenyloxy silane (Component D) and 0.4 parts by weight of Vinyltrimethoxysilane (Component E). The latter were mixed into the polymer blend until a smooth dispersion was obtained. This was followed by the addition of 0.3 parts by weight of γ-aminopropyltriethoxysilane (Component C1).

To the above blend was added 12.0 parts by weight of hydrophobised fumed silica (Degussa R972) (Component B1). The latter was mixed into the polymer blend until a smooth, agglomerate-free dispersion was obtained after which approximately 2.5 parts by weight of a hydrophilic fumed silica (Cab-O-Sil LM150) (Component B2) were added and mixed until fully dispersed (These fillers are Components B). To the above blend 6.5 parts by weight of Red Iron Oxide was added and blended until a uniform mixture was obtained. A second quantity of 1.0 part by weight of γ-aminopropyltriethoxysilane (Component C2) was then added followed immediately by 0.5 parts by weight of 1,1,3,3-Tetramethylguanidine (Component F). All the above procedures were carried out under controlled vacuum.

A sealant, Example 2(a) according to the invention and a comparative sealant 2(b) were prepared. The test results are given in Table 3.

TABLE 3

Example

| (Parts by weight) | 2(a) | 2(b) |
|---|---|---|
| Polymer Blend | 100 | 100 |
| Red Iron Oxide | 6.5 | 6.5 |
| Vinyl tris-isopropenyloxy silane | 7.8 | — |
| Vinyltrimethoxysilane | 0.40 | — |
| Methyl tris-(2-butanoximo)silane | — | 4.50 |
| Vinyl tris-(2-butanoximo)silane | — | 0.70 |
| γ-aminopropyltriethoxysilane (i) | 0.30 | — |
| Aerosil R972 (Degussa) | 12.0 | 12.0 |
| Cab-O-Sil LM150 (Cabot) | 2.5 | 2.5 |
| γ-aminopropyltriethoxysilane (ii) | 1.00 | 0.55 |
| Dibutyltin dilaurate | — | 0.05 |
| 1,1,3,3-Tetramethylguanidine | 0.50 | — |

The above formulations were thixotropic products with a slump of less than 3 mm when tested on a Boeing Jig. They were stable for at least 12 months at ambient temperatures and exhibited no significant change in properties after storing at 40° C. for 3 months. Samples were examined for the mode of adhesive failure, temperature resistance according to BS and for any corrosive action or surface attack. The results are summarized in Table 4. Example 2B failed to exhibit the same high level of temperature resistance as example 2A.

TABLE 4

| | Example | | | |
|---|---|---|---|---|
| Test | 2(a) | | 2(b) | |
| Tack Free Time, min | <3 | | 9 to 10 | |
| Cure Through, hours | <16 | | 24 | |
| Tensile Strength, MPa | 2.4 | | 2.3 | |
| Elongation at Break, % | 400 | | 210 | |
| Hardness, Shore A | 40 | | 40 | |
| Temperature | 300 | | 250 | |
| resistance ° C. | | | | |
| Adhesion- | Fail Mode | Corrosion | Fail Mode | Corrosion |
| Stainless Steel | Cohesive | 1 | Cohesive | 1 |
| Aluminium | Cohesive | 1 | Cohesive | 1 |
| PC Polyester | Cohesive | 1 | Cohesive | 2 |
| Copper | Cohesive | 1 | Cohesive | 5 |
| Brass | Cohesive | 1 | Cohesive | 4 |

Additional examples of conventional RTVs are given below for comparison. Comparative examples 3-4 are conventional ratios and compositions.

### EXAMPLE 3

### Comparative Example

A comparative example mixture was prepared adding 100% of Component C into the mixture prior to the addition of Component B1 and Component B2. The resulting order of addition included: silicone polymers (Component A), crosslinking agent (Component D), amino-functional silane (Component C), hydrophobised fumed silica (Component B1), hydrophilic fumed silica (Component B2), alkoxy silane (Component E), and a curing agent (Component F). This mixture produced a reasonably good finished product, but testing showed the adhesion to most substrates was poor and resulted in adhesive failure of the bond.

### EXAMPLE 4

### Comparative Example

A comparative example mixture was prepared adding 50% of Component C (Component C1) into the mixture prior to the addition of Component B1 and the balance of Component C (Component C2) prior to the addition of Component B2. The resulting order of addition included: silicone polymers (Component A), crosslinking agent (Component D), 50% of the amino-functional silane (Component C1), hydrophobised fumed silica (Component B1), 50% of the amino-functional silane (Component C2), hydrophilic fumed silica (Component B2), alkoxy silane (Component E), and a curing agent (Component F). This mixture produced a reasonably good sealant with good adhesion properties to most substrates. However, the cure rubbers were not sufficiently snappy.

### SUMMARY

A method and composition for making a RTV organopolysiloxane composition including mixing in the following preferable order at least one organopolysiloxane polymer molecule (component A), an organic silicon compound (component D), an organic silicon compound (component E), a first portion of an amino-functional silane or derivative of such substance (component C1), a finely divided hydrophobised silica filler (component B1), a finely divided hydrophilic silica filler (component B2), a second portion of an amino-functional silane or derivative of such substance, and an organic imine curing catalyst.

Although there has been described what is at present considered to be the preferred embodiments of the present invention, it will be understood that the invention can be embodied in other specific forms without departing from the spirit or essential characteristics thereof. The present embodiments are, therefore, to be considered in all aspects as illustrative and not restrictive. The scope of the invention is indicated by the appended claims rather than the foregoing description.

What is claimed:

1. A method for making a RTV organopolysiloxane composition having improved non-corrosive properties and being free from organometallic catalysts comprising:
mixing at least one organopolysiloxane polymer molecule (component A) containing at least two hydroxyl groups each attached to the terminal silicon atoms in said molecule to produce an organopolysiloxane polymer mixture having a viscosity from 50 to 500,000 mPa·s at 25° C.;
mixing into said organopolysiloxane polymer mixture an organic silicon compound (component D) of the following formula (I):
RₙSiX₄₋ₙ (I)
wherein R is a substituted or unsubstituted monovalent hydrocarbon group of 1 to 10 carbon atoms, X is a 1-methylvinyloxy group, and letter n is equal to 0, 1 or 2;
mixing into said organopolysiloxane polymer mixture an organic silicon compound (component E) of the following formula (II):
Rₚ¹SiX₄₋ₚ (II)
wherein R¹ is a methyl, vinyl or substituted vinyl group and X is methoxy or ethoxy or a mixture of methoxy and ethoxy, letter p is equal to 0, 1 or 2;
mixing into said organopolysiloxane polymer mixture a first portion of an amino-functional silane or derivative of such substances (component C1);
mixing into said organopolysiloxane polymer mixture a finely divided hydrophobised silica filler (component B1);
mixing into said organopolysiloxane polymer mixture a finely divided hydrophilic silica filler (component B2);
mixing into said organopolysiloxane polymer mixture a second portion of an amino-functional silane or derivative of such substances (component C2); and
mixing into said organopolysiloxane polymer mixture an organic imine curing catalyst (component F) of the following formulas (IIIa) and (IIIb): 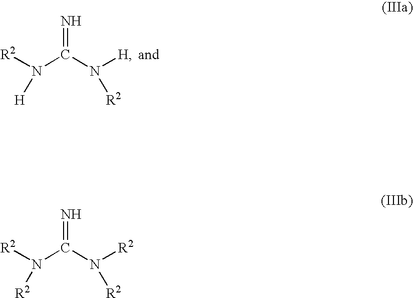
wherein each R² is independently selected from the group consisting of methyl, isopropyl, phenyl and ortho-tolyl groups to produce said RTV organopolysiloxane composition.

2. The method for making a RTV organopolysiloxane composition of claim 1 further comprising:
mixing into said organopolysiloxane polymer mixture a pigment material.

3. The method for making a RTV organopolysiloxane composition of claim 1, wherein said mixing is carried out under controlled vacuum.

4. The method for making a RTV organopolysiloxane composition of claim 1, wherein said component A comprises a organopolysiloxane described by formula (IV) 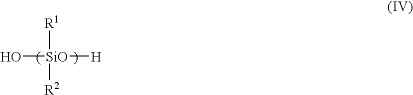
wherein R¹ and R² may be the same or different and are independently selected from group consisting of methyl, ethyl, propyl, butyl, cyclohexyl, vinyl, allyl, tolyl, benzyl, octyl, 2-ethylhexl, trifluoropropyl and cyanoethyl and r is a number to provide an organopolysiloxane that exhibits said viscosity.

5. The method for making a RTV organopolysiloxane composition of claim 1, wherein said component A comprises at least two organopolysiloxane polymer molecules having a viscosity of about 100 to 100,000 mPa·S. at 25° C.

6. The method for making a RTV organopolysiloxane composition of claim 1, wherein said component B1 and component B2 are selected from the group consisting of fused silica, fumed silica, precipitated silica and powdered quartz.

7. The method for making a RTV organopolysiloxane composition of claim 1, wherein said component C1 and component C2 is selected from the group consisting of γ-aminopropyltriethoxysilane, γ-aminopropyltrimethoxysilane, β-aminoethyl-γ-aminopropyltrimethoxysilane, Triaminofunctional silane, N-phenyl-γ-aminopropyltrimethoxysilane, Bis-[γ-(trimethoxysilyl)propyl]amine and N-β-aminoethyl-γ-aminopropylmethyldimethoxysilane.

8. The method for making a RTV organopolysiloxane composition of claim 1, wherein said component D is selected from the group consisting of vinyl tris-isopropenyloxysilane, methyl tris-isopropenyloxysilane and phenyl tris-isopropenyloxysilane.

9. The method for making a RTV organopolysiloxane composition of claim 1, wherein said component E is selected from the group consisting of methyltriethoxysilane, methyltrimethoxysilane, methyltrimethoxysilane, vinyltriethoxysilane and vinyltrimethoxysilane.

10. The method for making a RTV organopolysiloxane composition of claim 1, wherein said component F is selected from the group consisting of 1,3-diphenylguanidine, 1,3-di-o tolylguanidine, 1,3-dimethylguanidine and 1,1,3,3-tetramethylguanadine.

11. The method for making a RTV organopolysiloxane composition of claim 1 further comprising:
mixing into said organopolysiloxane polymer mixture a thermal stabilizing agent.

12. The method for making a RTV organopolysiloxane composition of claim 11, wherein said thermal stabilizing agent is selected from the group consisting of iron oxide, titanium dioxide and cerium oxide.

13. The method for making a RTV organopolysiloxane composition of claim 2, wherein said pigment material is selected from the group consisting of pigment masterbatch, carbon black, and titanium dioxide.

14. The product by process of claim 1.

15. The product by process of claim 2.

16. The product by process of claim 3.

17. The product by process of claim 4.

18. The product by process of claim 5.

19. The product by process of claim 6.

20. The product by process of claim 7.

21. The product by process of claim 8.

22. The product by process of claim 9.

23. The product by process of claim 10.

24. The product by process of claim 11.

25. The product by process of claim 12.

26. The product by process of claim 13.

27. A RTV organopolysiloxane composition having improved non-corrosive properties and being free from organometallic catalysts comprising as their main components:
(A) an organopolysiloxane polymer molecule containing at least two hydroxyl groups each attached to the terminal silicon atoms in said molecule and that the organopolysiloxanes used may have a viscosity from 50 to 500,000 mPa·s at 25° C.;
(D) an organic silicon compound of the following formula (1):
RₙSiX₄₋ₙ (I)
wherein R is a substituted or unsubstituted monovalent hydrocarbon group of 1 to 10 carbon atoms, X is a 1-methylvinyloxy group, and letter n is equal to 0, 1 or 2;
(E) an organic silicon compound of the following formula (II):
Rₚ¹SiX₄₋ₚ (II)
wherein R¹ is a methyl, vinyl or substituted vinyl group and X is methoxy or ethoxy or a mixture of methoxy and ethoxy, letter p is equal to 0, 1 or 2;
(C1) a first portion of an amino-functional silane or derivative of such substances;
(B1) a finely divided hydrophobised silica filler,
(B2) a finely divided hydrophilic silica filler,
(C2) a second portion of an amino-functional silane or derivative of such substances; and
(F) an organic imine curing catalyst of the following formulas (IIIa) and (IIIb): 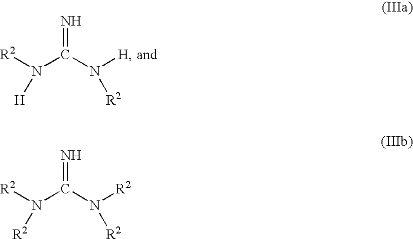
wherein each R² is independently selected from the group consisting of methyl, isopropyl, phenyl and ortho-tolyl groups.

28. The RTV organopolysiloxane composition of claim 27, wherein said component (A) comprises a organopolysiloxane described by formula (IV) 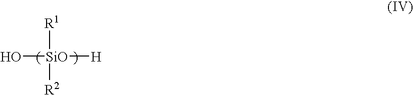
wherein R¹ and R² may be the same or different and are independently selected from group consisting of methyl, ethyl, propyl, butyl, cyclohexyl, vinyl, allyl, tolyl, benzyl, octyl, 2-ethylhexl, trifluoropropyl and cyanoethyl and r is a number to provide an organopolysiloxane that exhibits said viscosity.

29. The RTV organopolysiloxane composition of claim 27, wherein said component (A) comprises at least two organopolysiloxane polymer molecules having a viscosity of about 100 to 100,000 mPa·S. at 25° C.

30. The RTV organopolysiloxane composition of claim 27, wherein said component (B1) and (B2) are selected from the group consisting of fused silica, fumed silica, precipitated silica and powdered quartz.

31. The RTV organopolysiloxane composition of claim 27, wherein said component (C) is selected from the group consisting of γ-aminopropyltriethoxysilane, γ-aminopropyltrimethoxysilane, β-aminoethyl-γ-aminopropyltrimethoxysilane, Triaminofunctional silane, N-phenyl-γ-aminopropyltrimethoxysilane, Bis-[γ-(trimethoxysilyl)propyl]amine and N-β-aminoethyl-γ-aminopropylmethyldimethoxysilane.

32. The RTV organopolysiloxane composition of claim 27, wherein said component (D) is selected from the group consisting of vinyl tris-isopropenyloxysilane, methyl tris-isopropenyloxysilane and phenyl tris-isopropenyloxysilane.

33. The RTV organopolysiloxane composition of claim 27, wherein said component (E) is selected from the group consisting of methyltriethoxysilane, methyltrimethoxysilane, methyltrimethoxysilane, vinyltriethoxysilane and vinyltrimethoxysilane.

34. The RTV organopolysiloxane composition of claim 27, wherein said component (F) is selected from the group consisting of 1,3-diphenylguanidine, 1,3-di-o-tolylguanidine, 1,3-dimethylguanidine and 1,1,3,3-tetramethylguanadine.
